(19) United States
(12) Patent Application Publication
(10) Pub. No.: US 2010/0107533 A1
(43) Pub. Date: May 6, 2010

(54) SELF-SEALING FURRING ASSEMBLY

(76) Inventor: Greg STEPHAN, Westlake Village, CA (US)

Correspondence Address: Arent Fox LLP, 555 West Fifth Street, 48th Floor, Los Angeles, CA, 90013, US

(21) Appl. No.: 12/265,631

(22) Filed: Nov. 5, 2008

(51) Int. Cl. E04B 2/02; F16B 15/00

(52) U.S. Cl. 52/342; 52/745.09; 411/439; 52/408

(57) ABSTRACT

A self-sealing furring assembly includes a spacer and a sealing member abutting the spacer. In another aspect of the disclosure, a self-sealing furring assembly configured to be installed between plaster lath and a frame for a structure, includes building paper mounted on framing for the structure, a sealing member, and a fastening member supporting the sealing member, wherein the fastening member includes a head a and a shank and extends through the plaster lath, the sealing member, and the building paper into the framing so that the plaster lath is between the head of the fastening member and the sealing member, the sealing member being compressed to seal the hole formed by the shank of the fastening member in the building paper. A method for installing an exterior building material to a framing is disclosed.

### BACKGROUND

1. Field

The present disclosure relates generally to furring products, and more particularly, to a self-sealing furring assembly and a self-sealing fastener assembly configured to provide a watertight alternative to components used by the building industry for attaching a waterproofing material to an exterior surface of the framing of a home.

2. Background

In the building industry, sealing out water from penetrating to the interior surfaces of a home is always desirable. Making structures watertight against rainwater, irrigation water, and any other moisture is a concern. Creating this seal against the effects of water may be accomplished best by wrapping the exterior surfaces of a home in a building paper and fastening the paper to the framing of a home or other structure. In applications where an exterior surface, such as siding, roofing, or plaster lath, is subsequently attached, fastening the exterior surface to the framing requires penetrating the sealing paper. In so doing, the integrity of the building paper may be compromised, allowing moisture to penetrate through the hole and mold, mildew, freeze, thaw, rot the wood, or cause other problems associated with waterproof exterior systems.

### SUMMARY

One aspect of the disclosure, a self-sealing furring assembly, includes a spacer and a sealing member abutting the spacer.

Another aspect of the disclosure, a self-sealing furring assembly configured to be installed between a plaster lath and a frame for a structure, includes building paper mounted on the frame for the structure, a sealing member and a fastening member supporting the sealing member, wherein the fastening member includes a head and a shank and extends through the plaster lath, the sealing member and the building paper into the framing so that the plaster lath is between the head of the fastening member and the sealing member, the sealing member being compressed to seal the hole formed by the shank of the fastening member in the building paper.

Another aspect of the disclosure, a method of installing plaster lath to a framing, includes wrapping the framing with building paper, placing a self-sealing furring assembly against the building paper in a location aligned with a member of the framing, supporting the plaster lath on a surface of the furring assembly, and extending a fastening member having through the building material, a sealing member, and the building paper into the framing so that the plaster lath is between a head of the fastening member and the sealing member, and the sealing member compresses to seal the hole formed by the fastening member in the building paper.

Another aspect of the disclosure, a self-sealing fastener assembly, includes a spacer, a sealing member, and a fastening member supporting the spacer and the sealing member.

In another aspect of the disclosure, an exterior assembly for a structure having framing, includes building paper mounted on framing for the structure, a self-sealing fastener assembly including a spacer, a sealing member, and a fastening member extending through the spacer, the sealing member, and the building paper into the framing, the spacer compressing the sealing member to seal the hole formed by the fastening member in the building paper.

A method is disclosed for installing a self-sealing fastener assembly to a framing that includes wrapping the framing with building paper, placing a self-sealing fastener assembly against the building paper in a location aligned with a member of the framing placing the tip portion of the fastening member against the paper on the framing, and extending the fastening member through the spacer, the sealing member, and the building paper into the framing so that the spacer compresses the sealing member to seal the hole formed by the fastening member in the building paper.

### BRIEF DESCRIPTION OF DRAWINGS

Various aspects of the present invention are illustrated by way of example, and not by way of limitation, in the accompanying drawings, wherein:

FIG. 1 illustrates a side view of a self-sealing furring assembly;

FIG. 2 illustrates a side view of a self-sealing furring assembly, wherein the sealing member is an o-ring type;

FIG. 3 illustrates a side view of a self-sealing fling assembly, wherein the spacer has a recessed portion;

FIG. 4 illustrates a side view of a self-sealing furring assembly, wherein the spacer has a recessed portion and the sealing member has a beveled surface;

FIG. 5 illustrates a side view of a structural system for use with a variation of the self-sealing furring assembly, wherein the sealing member is uncompressed;

FIG. 6 illustrates a side view of a structural system for use with a variation of the self-sealing furring assembly, wherein the sealing member is compressed;

FIG. 7 illustrates a front perspective view of a structural system for use with variations of the self-sealing furring assembly;

FIG. 8 illustrates a side view of a self-sealing fastener assembly;

FIG. 9 illustrates a side view of a self-sealing fastener assembly, wherein the sealing member is an o-ring type;

FIG. 10 illustrates a side view of a self-sealing fastener assembly, wherein the spacer has a recessed portion;

FIG. 11 illustrates a side view of a self-sealing fastener assembly, wherein the spacer has a recessed portion and the sealing member has a beveled surface;

FIG. 12A illustrates a side view of a structural system for use with a variation of the self-sealing fastener assembly, wherein the sealing member is uncompressed;

FIG. 12B illustrates a side view of a structural system for use with a variation of the self-sealing fastener assembly, wherein the sealing member is compressed; and

FIG. 13 illustrates a front perspective view of a structural system for use with variations of the self-sealing fastener assembly.

### DETAILED DESCRIPTION

The detailed description set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details.

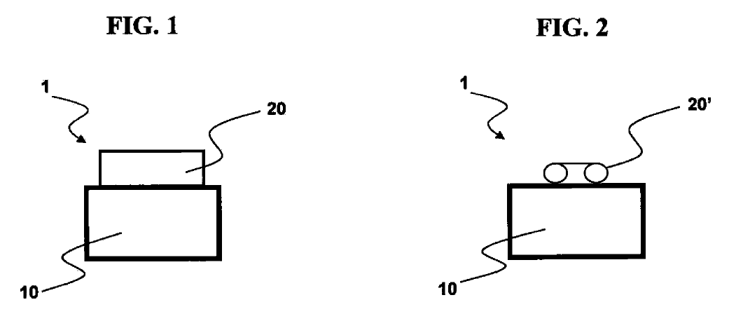

FIG. 1 illustrates a side view of an example of a self-sealing furring assembly 1. The self-sealing furring assembly 1 may include a spacer 10 and a sealing member 20. A lower surface of the sealing member 20 abuts an upper surface of the spacer 10. These surfaces may be adhered together by adhesive or affixed or held together in any other manner as would be evident to one of ordinary skill in the art. The spacer 10 may be comprised of any suitable material, including modified or unmodified bitumen, tar, plastic, rubber, cardboard, fiberglass, metal, and wood. The material choice is flexible as long as the spacer 10 can provide a space between an exterior surface of the structure to which the self-sealing furring assembly 1 is attached and any exterior building material subsequently attached to the structure. The spacer 10 may be manufactured to be round, square or rectangular to align easier to structural components or the exterior building material for easier fastening, but the spacer 10 may be made in any shape. The sealing member 20 may be comprised of any suitable compressible material, including modified or unmodified bitumen, tar, neoprene, fluoroelastomer, silicone, natural rubber, or any suitable synthetic rubber, for example. The compressible sealing member 20 may be manufactured to be round, square or rectangular to align easier with the spacer 10 and/or to structural components for fastening, but the sealing member 20 may be made in any shape. For example, FIG. 2 shows a sealing member 20′ that is an o-ring type and FIG. 4 shows a sealing member 20″ that includes a beveled surface 25.

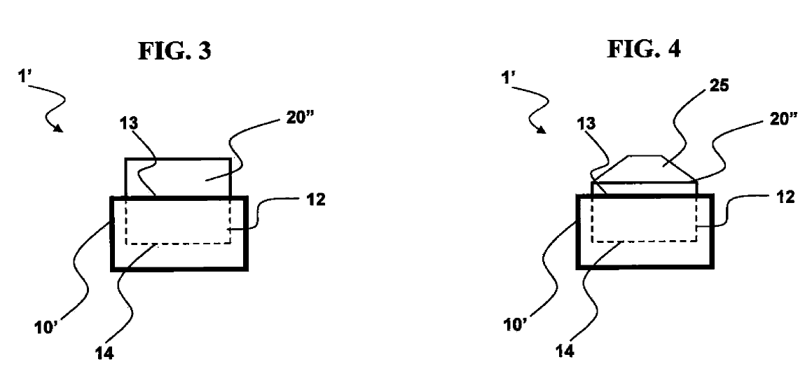

FIGS. 3 and 4 illustrate a variation of the self-sealing furring assembly 1′, wherein the spacer 10′ comprises a recessed portion 12. The sealing member 20″ may be designed to fit into an opening 13 and seat against the inside lower surface 14 of the recessed portion 12. The dimensions of the portion of the sealing member 20″ that fits within the recessed portion 12, such as the length and width or circumference, may be such that the exterior sidewall surfaces of the sealing member 20″ directly abut the inner side surfaces of the recessed portion 12. In so doing, the recessed portion 12 provides a secure seat for the sealing member 20″ in the spacer 10′. As illustrated in FIG. 4, the portion of the sealing member 20″ exterior to the recessed portion 12 may vary in shape and dimensions from the recessed portion 12. In FIG. 4, for example, the sealing member 20″ may include a beveled surface 25. Combined with the choice of material, the dimensions of the sealing member 20″ may be varied in order to achieve predetermined compression characteristics of the sealing member 20″. The self-sealing furring assembly 1′ may be completely assembled during manufacture or the individual components provided separately for assembly on-site or at a secondary facility. Moreover, the spacer 10′ may be interference fit, integrally formed or co-molded with the sealing member 20″.

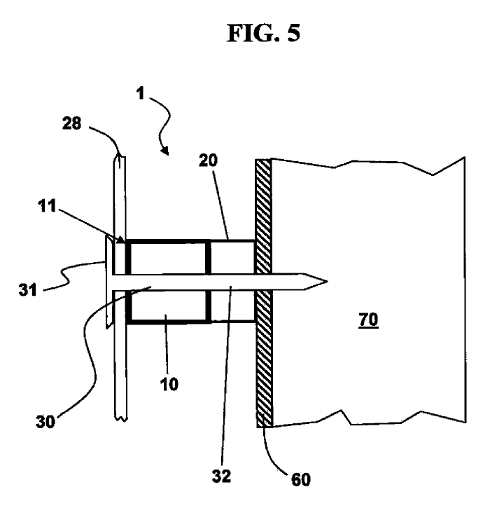

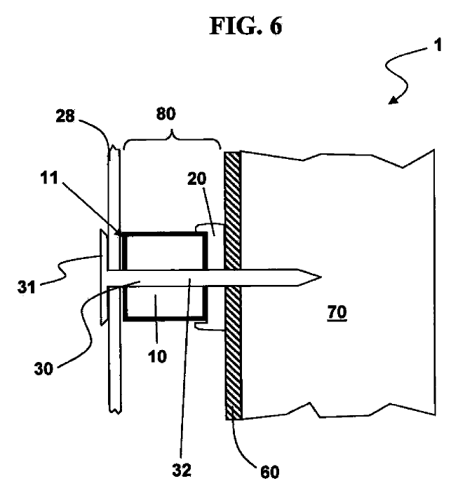

FIGS. 5 and 6 will be used to illustrate operation of the self-sealing furring assembly 1. A waterproofing material, such as building paper 60, is placed around the studs 70 (and where plywood is used over the studs 70 (not shown)) of a structure requiring waterproofing protection. The furring assemblies may be placed in position by aligning each furring assembly 1 with a stud 70 so that the bottom surface of the sealing member 20 faces the paper 60. The furring assembly 1 may have an adhesive on the bottom surface of the sealing member 20 so that the furring assembly 1 may be bonded in place to the paper 60 by simply pressing the furring assembly 1 against and in the direction of the stud 70. Alternatively, the fastening assembly 1 may be manually held in place while plaster lath 28, for example, is applied to the structure. The plaster lath 28 may be made of any suitable material, including wire.

Initially, as shown in FIG. 5, the plaster lath 28 is held up to the assembly 1 and a fastening member 30 is driven home through the plaster lath 28, the furring assembly 1, the paper 60 and into the stud 70. The fastening member 30 may be a furring nail, screw, bolt staple, or any other suitable fastener as would be evident to one of ordinary skill in the art. As the fastening member 30 drives through the spacer 10 and the sealing member 20 of furring assembly 1, the fastening member 30 compresses the sealing member thus enabling the self-sealing function of the assembly. The fastening member 30 may comprise a head 31 and a shank portion 32. The head 31 of the fastening member 30 abuts an exterior surface of the plaster lath 28, wherein continued driving causes the plaster lath 28 to be pinched between the head 31 of the fastening member 30 and an upper surface 11 of the spacer 10. While it may be desirable to always pinch a portion of the plaster lath 28 between the head 31 and the spacer 10, it is not always necessary. Continued driving of the fastening member 30 results in the head 31 of the fastener exerting a distributed force across the upper surface 11 of the spacer 10. The distributed force, in turn drives the spacer 10 toward the paper 60, compressing the sealing member 20, as illustrated in FIG. 6. The sealing member 20 is compressed between the spacer 10 and the exterior surface of the paper 60, creating a water tight seal around the shank 32 of the fastening member 30 in the area of the penetration hole (not shown) formed by the fastening member 30 entering the building paper 60. The compressed sealing member 20 will also cover or protect any enlargements of the penetration hole or small tears in the building paper 60 at the penetration hole due to shifting of the building paper 60 during the construction process caused by wind or other accidental movement or pressure on the building paper 60.

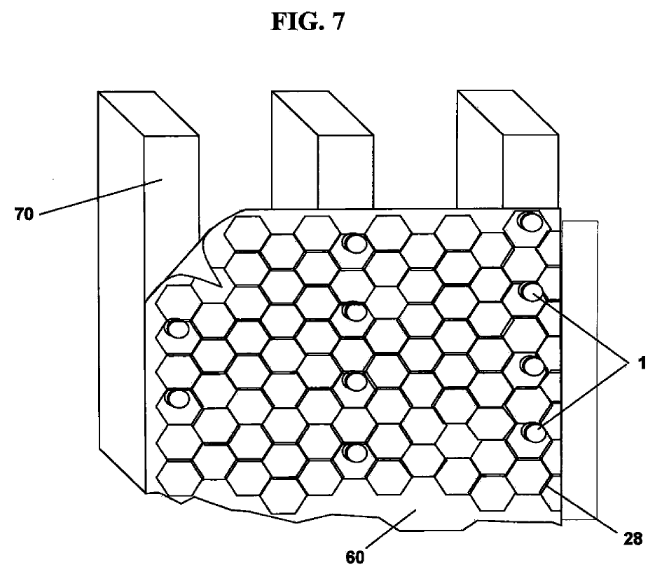

FIG. 7 illustrates an exterior section of a structure in which self-sealing furring assemblies 1 have been used to hang the plaster lath 28. The furring assemblies 1 may be placed at sixteen inch intervals from one another in a horizontal direction in accordance with the framing of the structure, but the furring assemblies 1 should be placed at no more than seven inch intervals in the vertical direction. The spacing may be provided according to the specific dimensions and requirements of the exterior material being used. The exterior building material may be a plaster or stucco material, but the furring assemblies may also work with any type of siding, such as bevel, lap, board and batten, channel, clapboard, shingle, or tongue and groove, or roofing, for example. As shown in FIG. 6, an air gap 80 may be enabled between the plaster lath 28 and the paper 60. The air gap 80 may function to keep everything dry by preventing moisture from building up and becoming trapped between the plaster lath 28 and the paper 60. The gap 80 also may serve as a drainage plane allowing any rain or water that gets behind the plaster lath 28 to flow down, out and away from the protected structure.

Although shown and described with reference to the spacer 10 and sealing member 20 as shown in FIG. 1, the description above applies to the o-ring type sealing member 20′ and the sealing members 20″ seated in the recessed furring wad assemblies 10′. The amount of any deformation caused by the compression of the sealing member 20 by the spacer 10 may be dependent on the choice of material and geometric configuration of each member. Furthermore, deformation of the sealing member 20 is not required to ensure a waterproof seal, as long as sufficient force is applied in driving the fastening member 30 home to ensure that the sealing member 20 is held with force against the paper 60 by the spacer 10.

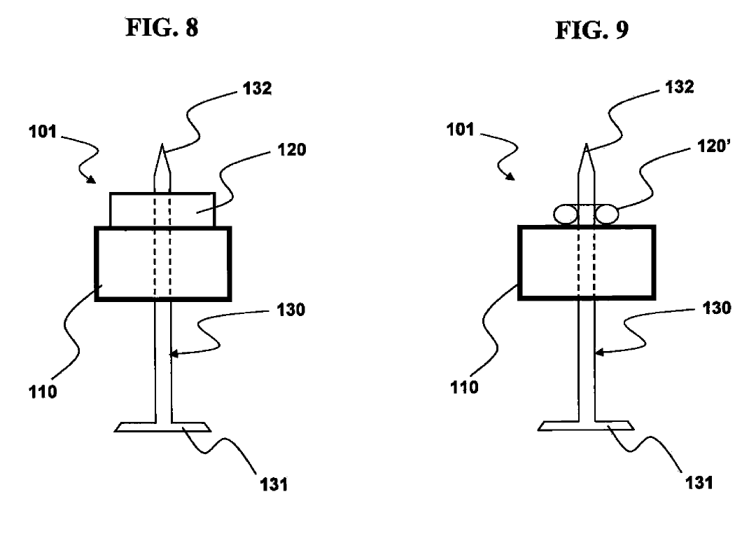

FIG. 8 illustrates a side view of an example of a self-sealing fastener assembly. The self-sealing fastener assembly 101 may include a spacer 110, a sealing member 120, and a fastening member 130. The spacer 110 is mounted on the fastening member 130 and may be comprised of any suitable material, including modified or unmodified bitumen, tar, a wide variety of plastics, rubbers, cardboard, fiberglass, metal, and wood. The material choice is flexible as long as the spacer 110 can provide a space between a head portion 131 of the fastening member 130 and an exterior surface of the structure to which the self-sealing fastener assembly 101 is attached. The spacer 110 may be manufactured to be round, square or rectangular to align easier to structural components for fastening, but the member may be made in any shape. The seal member 120 is mounted on the fastening member 130 adjacent to the spacer 110 so that seal member 120 is closer to the tip portion 132 of the fastening member 130. The spacer 110 is thus situated between the head portion 131 of the fastening member and the sealing member 120. The sealing member 120 may be comprised of any suitable compressible material, including modified or unmodified bitumen, tar, neoprene, fluoroelastomer, silicone, natural rubber, or any suitable synthetic rubber, for example. The compressible sealing member 120 may be manufactured to be round, square or rectangular to align easier with the spacer 110 and/or to structural components for fastening, but the member may be made in any shape. For example, FIG. 9 shows a sealing member 120′ that is an o-ring type coaxially mounted onto the shaft of the fastening member 130, and FIG. 11 shows a sealing member 120″ that includes a beveled surface 125. The fastening member 130 may be a nail, screw, bolt, staple, or any other suitable fastener as would be evident to one of ordinary skill in the art.

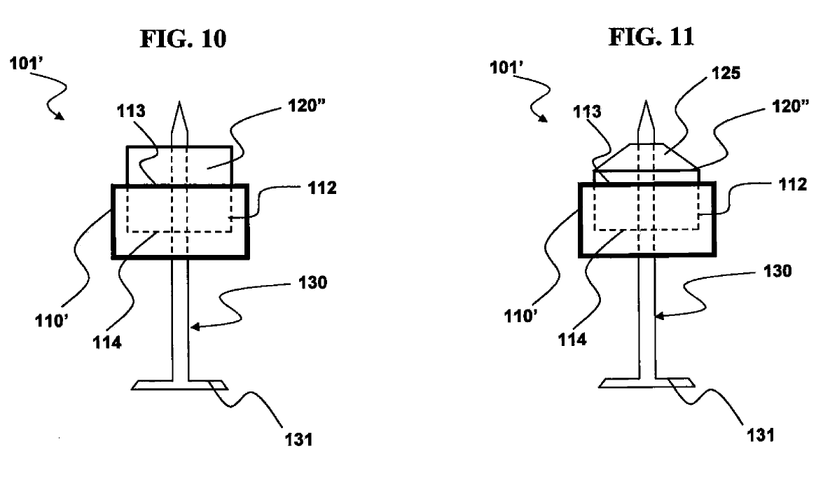

FIGS. 10 and 11 illustrate a variation of the self-sealing fastener assembly 101′, wherein the spacer 110′ comprises a recessed portion 112. The sealing member 120″ may be designed to slidably enter an opening 113 and seat against the inside lower surface 114 of the recessed portion 112. The dimensions of the portion of the sealing member 120″ that fits within the recessed portion 112, such as the length and width or circumference, may be such that the exterior sidewall surfaces of the sealing member 120″ directly abut the inner side surfaces of the recessed portion 112. In so doing, the recessed portion 112 provides a secure seat for the sealing member 120″ in the spacer 110. As illustrated in FIG. 11, the portion of the sealing member 120″ exterior to the recessed portion 112 may vary in shape and dimensions from the recessed portion 112. In FIG. 11, for example, the sealing member 120″ may include a beveled surface 125. Combined with the choice of material, the dimensions of the sealing member 120″ may be varied in order to achieve predetermined shape or force characteristics during compression of the sealing member 120″. The self-sealing fastener assembly 101′ may be completely assembled during manufacture or the individual components provided separately for assembly on-site or at a secondary facility. Moreover, the furring wad assembly 110′ may be integrally formed with the sealing member 120″.

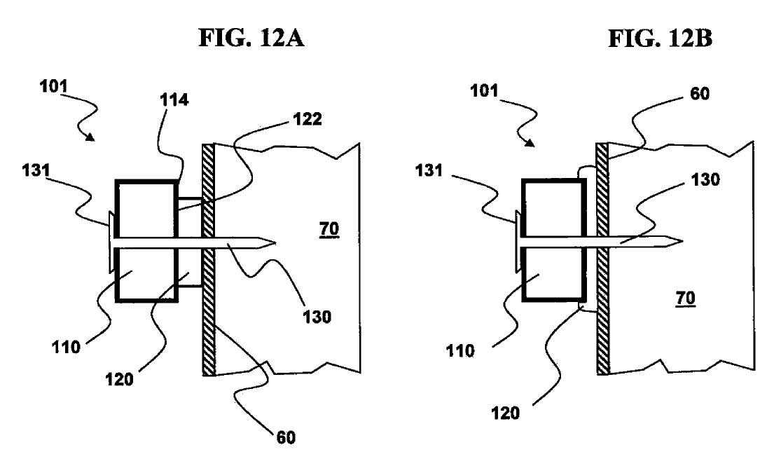

FIGS. 12A and 12B will be used to illustrate operation of the self-sealing fastener assembly 101 shown in FIG. 8. A waterproofing material, such as building paper 60, is placed around the studs 70 (and where plywood is used over the studs 70 (not shown)) of a structure requiring waterproofing protection. The fastener assemblies 101 may be placed in position by aligning each fastener assembly 101 with a stud 70 so that the bottom surface of the sealing member 120 faces the paper 60. The fastening member 130 is driven home through the spacer 110, the sealing member 120, paper 60 and into the stud 70. As shown in FIG. 12A, the fastening member 130 drives through the spacer 110 and the sealing member 120 until the head 131 of the fastening member 130 abuts an exterior surface of the spacer 110, wherein continued driving causes spacer 110 to exert a distributed force across an inner surface 114 abutting an outer surface 122 of the sealing member 120. The sealing member 120 is squeezed between the spacer 110 and the exterior surface of the paper 60. Continued driving of the nail 130, in turn, drives the spacer 110 further toward the paper 60, compressing the sealing member 120, as illustrated in FIG. 12B. The sealing member 120, by virtue of forced compression between the spacer 110 and the paper 60 creates a water tight seal that will cover any enlargements of the hole or small tears in the building paper 60 at the penetration hole due to shifting of the building paper 60 during the construction process caused by wind, or other accidental movement or pressure on the building paper 60.

Although shown and described with reference to the spacer 110 and sealing member 120 as shown in FIG. 8, the description above applies to the o-ring type sealing member 120′ and the sealing members 120″ seated in the recessed furring wad assemblies 110′. The amount of any deformation caused by the compression of the sealing member 120 by the spacer 110 may be dependent on the choice of material and geometric configuration of each member. Furthermore, deformation of the sealing member 120 is not required to ensure a waterproof seal, as long as sufficient force is applied in driving the fastening member 130 home to ensure that the sealing member 120 is pressed with force against the paper 60 by the spacer 110.

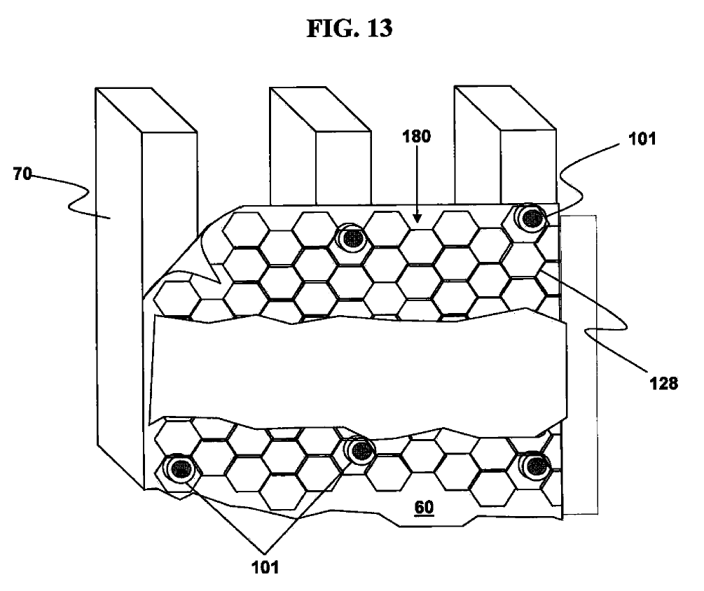

FIG. 13 illustrates an exterior section of a structure in which self-sealing fastener assemblies 101 have been used with a waterproofing material, such as building paper 60, for example. The fastener assemblies 101 may be placed at sixteen inch intervals from one another, horizontally, or no greater than seven inches apart vertically, or the spacing may be provided according to the specific dimensions and requirements of the exterior material being used. By using the fastener assemblies 101, it may be possible to create an air gap 180 between an exterior material 128, such as plaster lath, siding or roofing, for example, and the paper 60. The air gap 180 may function to keep everything dry by preventing moisture from building up and becoming trapped between the exterior material 128 and the paper 60. The gap 180 also may serve as a drainage plane allowing any rain or water that gets behind the exterior material 128 to flow down, out and away from the protected structure.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A self-sealing furring assembly, comprising:
a spacer; and
a sealing member abutting the spacer.

2. The self-sealing furring assembly of claim 1, wherein the sealing member comprises an o-ring.

3. The self-sealing furring assembly of claim 1, wherein the sealing member comprises modified or unmodified bitumen, tar, neoprene, fluoroelastomer, silicone, or rubber.

4. The self-sealing furring assembly of claim 1, wherein the sealing member comprises a beveled surface.

5. The self-sealing furring assembly of claim 1, wherein the spacer comprises a recessed portion.

6. The self-sealing furring assembly of claim 5, wherein the sealing member comprises a seat portion that fits into the recessed portion.

7. The self-sealing furring assembly of claim 1 wherein the spacer comprises modified or unmodified bitumen, tar, plastic, rubber, cardboard, fiberglass, metal, or wood.

8. The self-sealing furring assembly of claim 1, wherein the spacer and the sealing member are integrally formed.

9. The self-sealing furring assembly of claim 1, wherein the spacer is affixed to the sealing member.

10. The self-sealing furring assembly of claim 1, wherein the self-sealing furring assembly further comprises a fastening member supporting the spacer and the sealing member.

11. The self-sealing furring assembly of claim 10, wherein the fastening member comprises a nail.

12. A self-sealing furring assembly configured to be installed between a plaster lath and a frame for a structure, comprising:
building paper mounted on the frame for the structure;
a sealing member; and
a fastening member supporting the sealing member, wherein the fastening member includes a head and a shank and extends through the plaster lath, the sealing member and the building paper into the framing so that the plaster lath is between the head of the fastening member and the sealing member, the sealing member being compressed to seal the hole formed by the shank of the fastening member in the building paper.

13. The self-sealing furring assembly of claim 12 further comprising a spacer supported by the fastening member.

14. The self-sealing furring assembly of claim 13, wherein the spacer comprises a recessed portion.

15. The self-sealing furring assembly of claim 14, wherein the sealing member comprises a seat portion that fits into the recessed portion of the spacer.

16. The self-sealing furring assembly of Claim. 12, wherein the sealing member comprises modified or unmodified bitumen, tar, neoprene, fluoroelastomer, silicone, or rubber.

17. The self-sealing furring assembly of claim 12, wherein the sealing member comprises a beveled surface.

18. The self-sealing furring assembly of claim 12, wherein the sealing member comprises an o-ring.

19. The self-sealing furring assembly of claim 13, wherein the spacer comprises modified or unmodified bitumen, tar, plastic rubber, cardboard, fiberglass, metal, or wood.

20. The self-sealing furring assembly of claim 13, wherein the spacer and the sealing member are integrally formed.

21. The self-sealing furring assembly of claim 13, wherein the spacer is affixed to the sealing member.

22. The self-sealing furring assembly of claim 12, wherein the fastening member comprises a nail.

23. A method of installing a plaster lath to a framing, comprising:
wrapping the framing with building paper;
placing a self-sealing furring assembly against the building paper in a location aligned with a member of the framing, wherein the furring assembly includes:
a sealing member; and
a fastening member supporting the sealing member, wherein the fastening member includes a head and a shank;
supporting the plaster lath on a surface of the furring assembly; and
extending the fastening member through the building material, the sealing member, and the building paper into the framing so that the plaster lath is between the head of the fastening member and the sealing member, and the sealing member compresses to seal the hole formed by the shank of the fastening member in the building paper.

24. The method of installing a plaster lath to a framing of claim 23, wherein the furring assembly further comprises a spacer.

25. The method of installing a plaster lath to a framing of claim 24, wherein the spacer comprises a recessed portion.

26. The method of installing a plaster lath to a framing of claim 25, wherein the sealing member comprises a seat portion that fits into the recessed portion of the spacer.

27. A self-sealing fastener assembly, comprising:
a spacer;
a sealing member; and
a fastening member supporting the spacer and the sealing member.

28. The self-sealing fastener assembly of claim 27, wherein the seating member comprises an o-ring.

29. The self-sealing fastener assembly of claim 27, wherein the sealing member comprises modified or unmodified bitumen, tar, neoprene, fluoroelastomer, silicone or rubber.

30. The self-sealing fastener assembly of claim 27, wherein the sealing member comprises a beveled surface.

31. The self-sealing fastener assembly of claim 27, wherein the spacer comprises a recessed portion.

32. The self-sealing fastener assembly of claim 31, wherein the sealing member comprises a seat portion that fits into the recessed portion of the spacer.

33. The self-sealing fastener assembly of claim 27, wherein the spacer comprises modified or unmodified bitumen, tar, plastic, rubber, cardboard, fiberglass, metal, or wood.

34. The self-sealing fastener assembly of claim 27, wherein the spacer and the sealing member are integrally formed.

35. An exterior assembly for a structure having framing, the assembly comprising:
building paper mounted on the framing for the structure;
a self-sealing fastener assembly, the fastener assembly including:
a spacer;
a sealing member; and
a fastening member extending through the spacer, the sealing member, and the building paper into the framing, the spacer compressing the sealing member to seal the hole formed by the fastening member in the building paper.

36. The exterior assembly for a structure of claim 35, wherein the exterior assembly further comprises an exterior building material attached to the structure and abutting the fastener assemblies to create an air gap between the building material and the building paper.

37. The exterior assembly for a structure of claim 35, wherein the sealing member comprises modified or unmodified bitumen, tar, neoprene, fluoroelastomer, silicone, or rubber.

38. The self-sealing fastener assembly of claim 35, wherein the sealing member comprises a beveled surface.

39. A method of installing a self-sealing fastener assembly to a framing, comprising:
wrapping the framing with building paper;
placing a self-sealing fastener assembly against the building paper in a location aligned with a member of the framing, wherein the fastener assembly includes:
a spacer;
a sealing member; and
a fastening member comprising a tip portion and supporting the spacer and the sealing member;
placing the tip portion of the fastening member against the building paper on the framing; and
extending the fastening member through the spacer, the sealing member, and the building paper into the framing so that the spacer compresses the sealing member to seal the hole formed by the fastening member in the building paper.

40. The method of installing a self-sealing fastener assembly to a framing of claim 39, the method of installing a self-sealing fastener assembly to a framing further comprising attaching an exterior building material to the framing abutting the fastener assemblies to create a gap between the fastener assemblies and the building material.

41. The method of installing a self-sealing fastener assembly to a framing of claim 39, wherein the spacer comprises a recessed portion.

42. The method of installing a self-sealing fastener assembly to a framing of claim 41, wherein the sealing member comprises a seat portion that fits into the recessed portion of the spacer.
